(19) United States
(12) Patent Application Publication
(10) Pub. No.: US 2009/0285198 A1
(43) Pub. Date: Nov. 19, 2009

(54) APPARATUS AND METHODS FOR PROVIDING MEDIA PACKET FLOW BETWEEN TWO USERS OPERATING BEHIND A GATEWAY DEVICE

(75) Inventors: Richard Schwartz, San Diego, CA (US); Ray Farhat, Rancho Santa Fe, CA (US)

Correspondence Address: Weiss & Arons, LLP, 1540 Route 202, Suite 8, Pomona, NY, 10970, US

(73) Assignee: Broadcom Corporation, Irvine, CA (US)

(21) Appl. No.: 12/119,627

(22) Filed: May 13, 2008

(51) Int. Cl. H04L 12/66

(52) U.S. Cl. 370/352

(57) ABSTRACT

A method for supporting communication between a source internet protocol phone and a destination internet protocol phone is provided. The source internet protocol phone communicates via a Network Address Translator (“NAT”) gateway. The method includes receiving a packet from the source phone at the NAT. The packet is for communication with the destination phone. The method further includes querying whether the destination phone is located in the subnetwork serviced by the NAT gateway. If the destination phone is not located in the subnetwork serviced by the NAT gateway, then the method includes sending the packet upstream to the destination phone via the Internet. If the destination phone is located in the subnetwork serviced by the NAT gateway, then the method includes directing the packet to the destination phone.

### BACKGROUND

The present invention relates generally to media packet flow between two mobile phone users.

Call Session Control and Media Services applications, such as those based on SIP (Session Initiation Protocol (SIP) is a signaling protocol, widely used for setting up and tearing down multimedia communication sessions such as voice and video calls over the Internet), are required to use a public WAN (Wide Area Network) IP (Internet Protocol) Address in the call signaling message content and in the description of media exchange information.

A client mobile phone using a public WAN may not know the translated WAN IP address that the it is using. A client using such applications may discover its public WAN IP address by using protocols such as STUN. STUN is “Simple Traversal of UDP through NATS” (STUN)—a network protocol allowing a client behind a NAT to find out its public address, the type of NAT it is behind and the internet-side port associated by the NAT with a particular local port. This information is used to set up UDP (User Datagram Protocol) communication between two hosts that are both behind separate NAT routers. The protocol is defined in RFC (Request For Comments) 3489.

However, these applications will not work correctly behind a NAT gateway if both clients on a call reside behind the same gateway device IP. The NAT is typically implemented in software resident in a modem, such as a cable modem, or other suitable modem.

It would be desirable to provide systems and methods that allow call session control and media service applications to work seamlessly, preferably independent of the locations of the respective clients.

It would also be desirable to provide systems and methods that allow call session control and media service applications to work between two clients that reside behind a single NAT gateway.

### SUMMARY OF THE INVENTION

A system and/or method for providing media packet flow between two users operating behind a gateway device, substantially as shown in and/or described in connection with at least one of the figures, as set forth more completely in the claims.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 illustrates a schematic diagram of a general-purpose digital computing environment in which one or more aspects of the present invention may be implemented;

FIG. 2 is an illustrative flow diagram of a method according to the invention;

FIG. 3 shows an illustrative flow diagram of a method according to the invention; and

FIG. 4 is a schematic diagram of an illustrative single or multi-chip module of this invention in a data processing system.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

A SIP Server resides remotely from the NAT gateway. The SIP server controls setting up a call between two SIP phones. Typically, when a source SIP phone attempts to call a destination SIP phone, the SIP server informs the destination phone that an invite has been sent from a source phone. The source phone is identified by the public IP address associated with the NAT gateway that is in front of the source phone—i.e., between the NAT gateway servicing the source phone and the internet. The source phone is further identified to the destination phone by a source port—i.e., a numeric identifier—associated with the source phone. In addition, the destination phone must also be associated with a public IP address and a destination port.

In order to maintain the phone call, the destination phone is required to continue to see packets that identify the aforementioned public IP address as well as the source port. An example of such an identification of a public IP address may be 192.168.0.10; an example of a SIP source port number for the first phone may be 51000 or some other suitable number.

One reason that call session control and media service applications, such as those based on SIP, do not work correctly behind a NAT gateway (alternatively referred to herein as a “NAT”) when both clients reside behind the same gateway device IP is that both clients are assigned the same global address which is the public address of the gateway device. Typically, conventional NATs do not handle call session control messages and media packets going to its global address that have been sent from its local side.

According to RFC 3489 (at pages 40-41) (http://tools.ietf.org/html/rfc3489), the preceding problem is known. RFC 3489 states in pertinent part:
STUN imposes some restrictions on the network topologies for proper operation. If client A obtains an address from STUN server X, and sends it to client B, B may not be able to send to A using that IP address. The address will not work if any of the following is true:
The STUN server is in an address realm that is a common ancestor to both clients, but both clients are behind the same NAT connecting to that address realm. For example, if the two clients in the previous example had the same cable operator, that cable operator had a single NAT connecting their network to the public Internet, and the STUN server was on the public Internet, the address obtained by A would not be usable by B. That is because some NATs will not accept an internal packet sent to a public IP address which is mapped back to an internal address. To deal with this, additional protocol mechanisms or configuration parameters need to be introduced which detect this case.

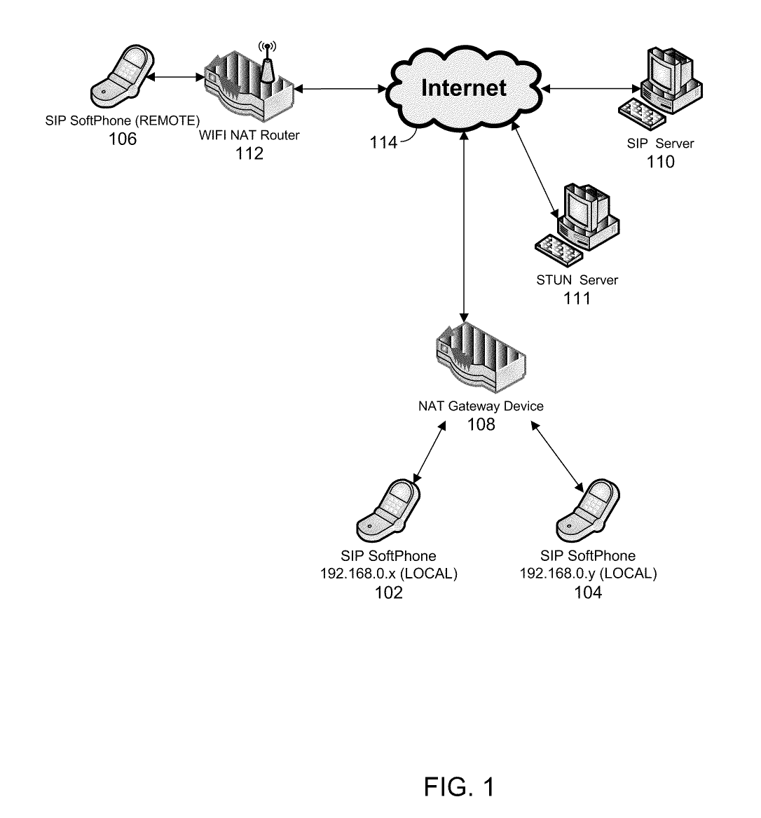

FIG. 1 shows an exemplary first situation in which the invention can be implemented. Both SIP softphones 102 and 104 can connect to SIP softphone 106. The problem arises when softphone 102 tries to connect to softphone 104. The problem arises because both softphone 102 and softphone 104 are behind the same NAT gateway device 108. Also shown in FIG. 1 are SIP Server 110 (the SIP server sets up the call), STUN server 111 (which is a different server; STUN server may be used to inform the client of its public IP address and port number), WIFI NAT Router 112 (such as a Linksys WRG router), and, schematically, the Internet 114.

Without a technique according to the invention, media packets do not traverse correctly between two clients—i.e., softphone 102 and softphone 104—behind gateway device 108. Specifically, two SIP clients would typically not be able to exchange media packets when the two SIP clients are attempting to communicate with each other behind a single gateway device.

A method according to the invention may preferably implement hairpinning to overcome this problem. In general telecommunication, hairpinning is returning a message from an origin endpoint back in the direction it came from as a way to get the message to its destination endpoint.

Because an origin endpoint and its router in a subnetwork may not recognize that a message is intended for a destination endpoint in the same subnetwork (at least because the router only knows its public IP address and not the individual addresses in its own subnetwork), the Internet Network Address Translation (NAT) gateway device must be able to recognize the situation and hairpin the message back to the subnetwork so that it can reach its destination.

However, simple hairpinning will be insufficient to solve the problem presented above. First, if hairpinning is not used, then the packets sent between the two devices would be dropped. If hairpinning is used, but the same NAT spoofing—i.e., the same, sometimes random, assignment of a NAT controlled translated source port to the source phone—is not used by both clients, then the packets will be sent, but they would be misinterpreted by the other device, because of a wrong port number. In this case, no audio would be heard by the clients.

Thus, in the absence of techniques according to the invention, a system is typically not able to support two devices located behind a single NAT gateway device when the two devices send media packets to communicate with each other. One real world example of such a situation follows: if two employees are working in the same small office, employee A would not be able to communicate using his SIP phone to call employee B's SIP phone.

Also, with systems that transfer user cell service to home or office service when a user moves from one environment to another, similar problems may occur. For example, when employee A using his SIP phone calls employee B's cell phone, and B's number has been transferred to his local SIP phone, the call may not continue successfully in the absence of techniques according to the invention. Thus, techniques according to the invention may help to overcome these problems.

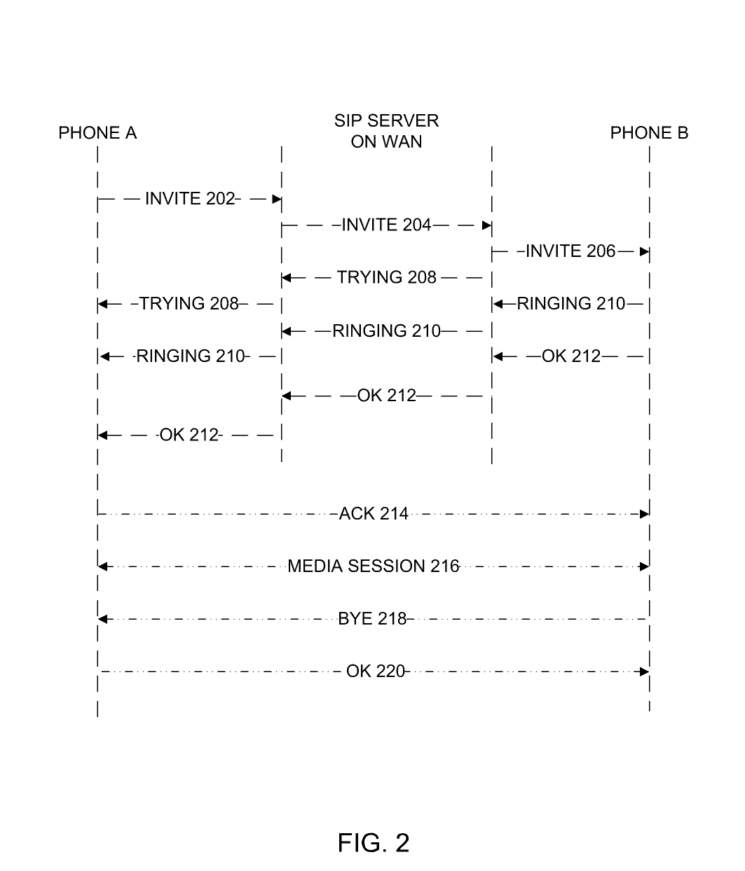

FIG. 2 shows an exemplary call signaling schematic that further illustrates the problem according to the invention. First, phone A sends invite 202 to the SIP Server on WAN. The Proxy Server then sends invite 204 as an invite 206 to Phone B.

At this point, the SIP Server communicates a trying message 208 to phone A to indicate the SIP Server is trying to communicate with phone B. Phone B may send a ringing signal 210 to the SIP Server, which may transfer ringing signal 210 to Phone A to further indicate the attempted contact is progressing.

When Phone B picks up, an OK signal 212 may be communicated by the SIP Server to Phone A. Thereafter, an acknowledgment message, ACK 214, may be communicated directly from phone A to phone B. The media session 216 may be maintained at 216. The session may be terminated when Phone B sends a bye signal 218 to Phone A. Finally, bye signal 218 may be followed by OK signal 220 communicated from Phone A to Phone B.

In typical SIP call signaling, phone A and phone B both use their respective Public WAN address in the SIP messages to access services on the WAN side. Because of the above-stated problem, the ACK signal 214, the BYE signal 218, and the OK signal 220 may not be routed correctly.

In addition, in SIP, the “Media Session” descriptions also make use of Public WAN addresses to indicate where media packets are to be sent. Because of the above-stated problem, media packets communicated in media session 216 may not be routed correctly.

One method according to the invention to solve the aforementioned problem may be as follows. SIP softphones may be wireless phones used to talk to a SIP/STUN server. As described above, the SIP server typically controls the call set-up. A SIP server typically uses an invite command to allow a first client to talk to another.

For a TCP/IP¹ or UDP/IP packet being sent from a source phone, such as SIP phone 102 in FIG. 1, to a destination phone located within SIP Phone 102's own Public IP address, NAT 108 first assumes that this is a packet going upstream, and a NAT tuple—i.e., a source phone IP number, such as 192.168.0.10, where 10 could be a predetermined two digit number which includes information such as source identification where 51000 is the source port, and a destination IP identification number, which could be 192.168.0.11, where 11 could identify the destination and the destination port is 52000—can be created for a new session. Alternatively, an existing tuple may be used for an existing session—i.e., if the conversation related to the present packet is an ongoing one, and NAT has already transferred packets from phone 102 to phone 104, then the NAT can use the Nat tuple serviced by the session already in progress. ¹ Packets may be transferred using Transmission Control Protocol (TCP). TCP is one of the core protocols of the Internet protocol suite. TCP provides reliable, in-order delivery of a stream of bytes. It is so important in the Internet protocol suite that sometimes the entire suite is referred to as “the TCP/IP protocol suite.” The transfer of The Internet Protocol (IP) operates by exchanging groups of information packets. Packets typically include short sequences of bytes consisting of a header and a body. The header describes the packet's destination, which routers on the Internet use to pass the packet along, in generally the right direction, until it arrives at its final destination. The body of the packet contains the application data.

If the session is determined to be a new session, then the tuple is searched to determine if a spoof port, which will replace the source port, at the NAT gateway 108 is needed. A spoof port may be required to identify the source port when SIP phone 102 and SIP phone 104 reside behind the same NAT gateway device 108. Specifically, a spoof port may be needed when the source port selected for the source phone has been used by NAT gateway 108 for a source port for a different phone in, for example, another tuple.

It should be noted that substantially the same implementation of NAT gateway 108 described above can be used for hairpinning packets and/or transferring typical upstream traffic, depending on the relative location of the source phone and the destination phone.

To reiterate, if the source port has been used as a source port for a different SIP phone, then the source port for the phone making the present call can be spoofed to be a different port number. The source IP address can then be replaced by its Public IP address including an identifier of the spoofed port.

The session table can be searched, if an existing session is found, then the source port and IP address can be replaced by what is found in the session table. Whether the source port has been spoofed or not, the session table can be updated to reflect that a packet has been sent upstream. The modified packet can then be used as a downstream packet.

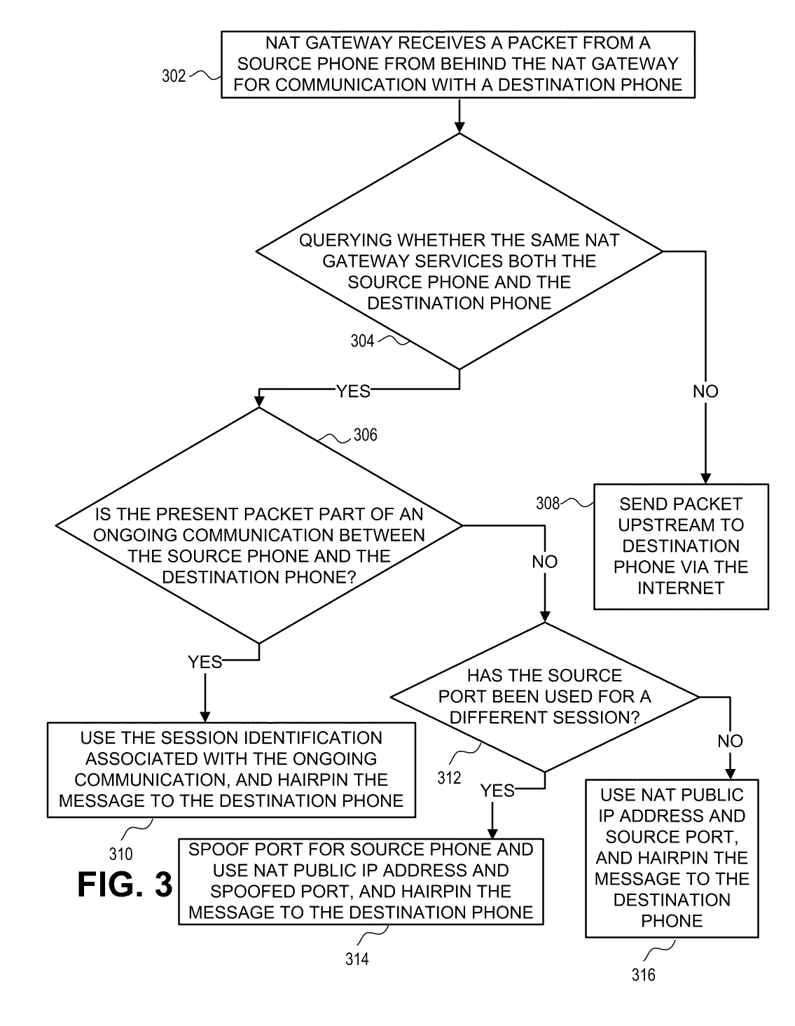

FIG. 3 shows an illustrative flow diagram of a method according to the invention that may be implemented in the software (or alternatively, the hardware, or some combination of software and hardware) of a NAT gateway. Step 302 shows a NAT gateway receiving a packet from a source phone that is located behind the NAT gateway. The packet has preferably been identified by the source phone for communication with a destination phone. Step 304 shows querying whether the same NAT gateway services both the source phone and the destination phone. In other words, Step 304 queries whether the NAT gateway that interfaces between the source phone and the internet also interfaces between the destination phone and the internet.

If the destination phone is located in the subnetwork serviced by the same NAT gateway as the source phone, then step 306 shows querying whether the present packet is part of an ongoing communication between the source phone and the destination phone. If the destination phone is not located in the subnetwork serviced by the same NAT gateway as the source phone, then step 308 shows sending the packet upstream to the destination phone via the Internet.

If the destination phone is located in the subnetwork serviced by the same NAT gateway as the source phone and the present packet is part of an ongoing communication between the source phone and the destination phone, then step 310 shows using the session identification serviced by the ongoing communication, and hairpinning the message to the destination phone.

If the destination phone is located in the subnetwork serviced by the same NAT gateway as the source phone but the present packet is not part of an ongoing communication between the source phone and the destination phone, then step 312 shows querying whether the source port has been used for a different session. If the source port has been used for a different session, then step 314 shows spoofing a source port and using the NAT Public IP Address and spoofed port, and hairpinning the message to the destination phone. If the source port has not been used for a different session, then step 316 shows using the NAT Public IP address and source port, and hairpinning the message to the destination phone.

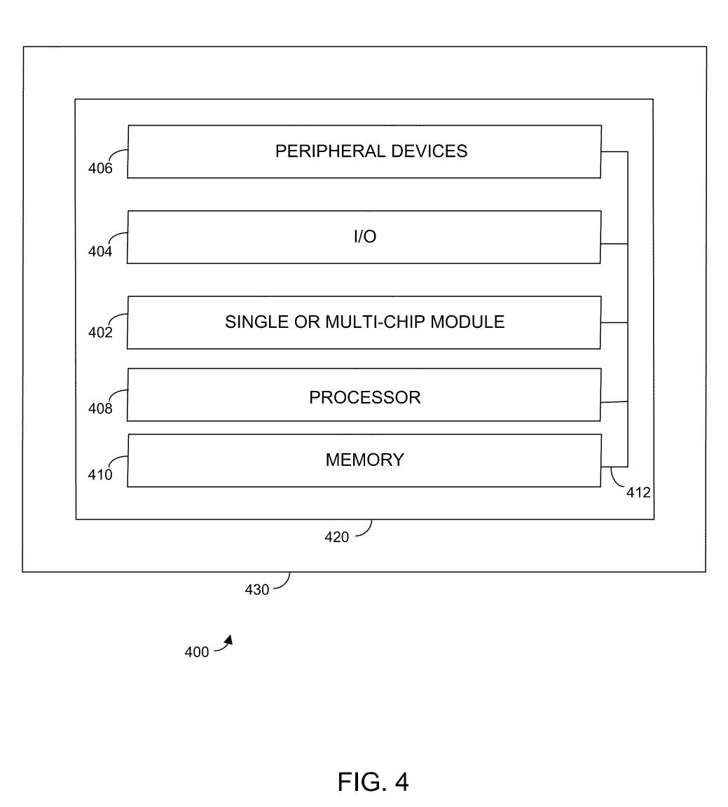

FIG. 4 shows a schematic diagram of an illustrative single or multi-chip module of this invention in a data processing system. Device 400 may include single or multi-chip module 402, which can be one or more integrated circuits, and which may include logic configured to: perform mathematical operations on signals representing signal noise power or to perform any other suitable logical operations. Device 404 may include one or more of the following components: I/O circuitry 404, which may interface with coaxial cable, telephone lines, wireless devices, output devices, a keypad/display control device or any other suitable media or devices; peripheral devices 406, which may include counter timers, real-time timers, power-on reset generators or any other suitable peripheral devices; processor 408, which may control process flow; and memory 410. Components 402, 404, 406, 408 and 410 may be coupled by a system bus or other interconnections 412 and may be present on one or more circuit boards such as 420. In some embodiments, the components may be integrated into a single chip.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Thus, systems and methods providing media packet flow between two users operating behind a gateway device have been provided. Aspects of the invention have been described in terms of illustrative embodiments thereof. A person having ordinary skill in the art will appreciate that numerous additional embodiments, modifications, and variations may exist that remain within the scope and spirit of the appended claims. For example, one of ordinary skill in the art will appreciate that the steps illustrated in the figures may be performed in other than the recited order and that one or more steps illustrated may be optional. The methods and systems of the above-referenced embodiments may also include other additional elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

What is claimed is:

1. A method for supporting communication between a source internet protocol phone and a destination internet protocol phone, the source internet protocol phone communicating via a Network Address Translator (“NAT”) gateway, the method comprising:
receiving a packet from the source phone at the NAT gateway, the source phone being located in a subnetwork serviced by the NAT gateway, the packet for communication with the destination phone;
determining whether the destination phone is located in the subnetwork serviced by the NAT gateway;
if the destination phone is not located in the subnetwork serviced by the NAT gateway, sending the packet upstream to the destination phone via the Internet; and
if the destination phone is located in the subnetwork serviced by the NAT gateway, directing the packet to the destination phone.

2. The method of claim 1 further comprising:
when the destination phone is located in the subnetwork serviced by the NAT gateway, querying whether the packet is part of an ongoing communication between the source phone and the destination phone; and
if the packet is part of an ongoing communication between the source phone and the destination phone, then using a session identification of the ongoing communication to transmit the message to the destination phone.

3. The method of claim 2 further comprising:
when the destination phone is located in the subnetwork serviced by the NAT gateway, but the present packet is not part of an ongoing communication between the source phone and the destination phone, querying whether a source port associated with the source phone has been used for a different phone associated with a different session.

4. The method of claim 3 further comprising:
when the source port associated with the source phone has been used for a different phone associated with a different session, spoofing a port for the source phone and using a NAT Public IP Address associated with the NAT gateway and the spoofed port to communicate the packet to the destination phone.

5. The method of claim 3 further comprising:
when the source port has not been used for a different phone associated with a different session, using a NAT Public IP address associated with the NAT gateway and source port.

6. One or more computer-readable media storing computer-executable instructions which, when executed by a processor on a computer system, perform a method for communicating packets between a source phone and a destination phone, the source phone communicating with the internet via a Network Address Translator (“NAT”) gateway, the method comprising:
receiving a packet from the source phone at the NAT gateway, the packet for communication with the destination phone;
determining at least in part based on information in the packet whether the destination phone is located in the subnetwork serviced by the NAT gateway;
if the destination phone is not located in the subnetwork serviced by the NAT gateway, then sending the packet upstream to the destination phone via the Internet; and
if the destination phone is located in the subnetwork serviced by the NAT gateway, directing the packet to the destination phone.

7. The method of claim 6 further comprising:
when the destination phone is located in the subnetwork serviced by the NAT gateway, querying whether the packet is part of an ongoing communication between the source phone and the destination phone; and
if the packet is part of an ongoing communication between the source phone and the destination phone, using a session identification of the ongoing communication to transmit the message to the destination phone.

8. The method of claim 7 further comprising:
when the destination phone is located in the subnetwork serviced by the NAT gateway, but the present packet is not part of an ongoing communication between the source phone and the destination phone, then querying whether a source port associated with the source phone has been used for a different phone associated with a different session.

9. The method of claim 8 further comprising:
when the source port associated with the source phone has been used for a different phone associated with a different session, then spoofing a source port and using a NAT Public IP Address associated with the NAT gateway and the spoofed port to communicate the packet to the destination phone.

10. The method of claim 8 further comprising:
when the source port has not been used for a different phone associated with a different session, then using a NAT Public IP address associated with the NAT gateway and source port.

11. A communication system for communication between a source internet protocol phone and a destination internet protocol phone, the communication between initiated using a Session Initiation Protocol (“SIP”) Server, the system comprising:
a Network Address Translator (“NAT”) gateway for supporting the communication between the source phone and the destination phone, the NAT gateway that provides an interface between each of the source phone and the destination phone with the internet, the internet that couples the NAT gateway to the SIP server, the NAT for receiving a packet from the source phone, for confirming whether the destination phone is located in the subnetwork serviced by the NAT gateway; and
wherein when the source phone and the destination phone are located in the subnetwork serviced by the NAT gateway, querying whether the packet is part of an ongoing communication between the source phone and the destination phone; and
if the packet is part of an ongoing communication between the source phone and the destination phone, then using a session identification of the ongoing communication to transmit the message to the destination phone.

12. The system of claim 11 wherein, if the destination phone is not located in the subnetwork serviced by the NAT gateway, the NAT for sending the packet upstream to the destination phone via the Internet; and
if the destination phone is located in the subnetwork serviced by the NAT gateway, the NAT gateway for directing the packet to the destination phone.

13. The system of claim 11 further comprising:
when the destination phone is located in the subnetwork serviced by the NAT gateway, but the present packet is not part of an ongoing communication between the source phone and the destination phone, then the NAT gateway for querying whether a source port has been used for a different phone associated with a different session.

14. The system of claim 13 further comprising:
when the source port has been used for a different phone associated with a different session, then the NAT gateway for selecting a source port and using a NAT Public IP Address associated with the NAT gateway and the selected port to communicate the packet to the destination phone.

15. The system of claim 13 further comprising:
when the source port has not been used for a different phone associated with a different session, then the NAT gateway for using a NAT Public IP address associated with the NAT gateway and source port.

16. A method for supporting communication between a source internet protocol phone and a destination internet protocol phone, the source internet protocol phone communicating via a Network Address Translator (“NAT”) gateway, the method comprising:
receiving a packet from the source phone at the NAT gateway, the packet identified for transmission to the destination phone;
when the destination phone is located in the subnetwork serviced by the NAT gateway, but the present packet is not part of an ongoing communication between the source phone and the destination phone, then querying whether a source port has been used for a different phone associated with a different session.

17. The method of claim 16 further comprising:
if the packet is part of an ongoing communication between the source phone and the destination phone, then using an identifier of the ongoing communication to transmit the message to the destination phone.

18. The method of claim 17 further comprising:
if the destination phone is not located in the subnetwork serviced by the NAT gateway, then sending the packet upstream to the destination phone via the Internet; and
if the destination phone is located in the subnetwork serviced by the NAT gateway, then directing the packet to the destination phone.

19. The method of claim 16 further comprising:
when the source port has been used for a different phone associated with a different session, selecting a source port and using a NAT Public IP Address associated with the NAT gateway and the spoofed port to communicate the packet to the destination phone.

20. The method of claim 16 further comprising:
when the source port has not been used for a different session, using a NAT Public IP address associated with the NAT gateway and source port.
